(19) United States
(12) Patent Application Publication
(10) Pub. No.: US 2018/0252975 A1
(43) Pub. Date: Sep. 6, 2018

(54) ELECTRONIC DISPLAY DEVICE AND DRIVE METHOD FOR SAME

(71) Applicant: NEC Corporation, Minato-ku, Tokyo (JP)

(72) Inventor: Hiroyuki ENDOH, Tokyo (JP)

(73) Assignee: NEC Corporation, Minato-ku, Tokyo (JP)

(21) Appl. No.: 15/756,727

(22) PCT Filed: Sep. 12, 2016
(86) PCT No.: PCT/JP2016/004142

§ 371 Date: Mar. 1, 2018

(30) Foreign Application Priority Data
Sep. 15, 2015 (JP) 2015-181727

(51) Int. Cl. G02F 1/155; G02F 1/163; G02F 1/161; G02F 1/15

(52) U.S. Cl. CPC G02F 1/155; G02F 1/1521; G02F 1/161; G02F 1/163

(57) ABSTRACT

The present invention is intended to provide an electronic display device capable of displaying even when power source supply is interrupted or the entire device is deformed or the like. The present invention provides an electronic display device including: an electrochromic element including first and second transparent electrodes, first and second electrochromic thin films which are formed on the first and second transparent electrodes and at least one of which is charged and thus has optical transparency, and an electrolyte filled between the first and second electrochromic thin films; and an electrode short-circuit mechanism which causes a short circuit between the first and second transparent electrodes by an external disturbance, thereby emitting a charge and generating a color.

### TECHNICAL FIELD

The present invention relates to an electronic display device using an electrochromic element, and a drive method for the same.

### BACKGROUND ART

Many kinds or types of electronic display devices used for a poster, a bulletin board, and the like used in a public facility such as a station, a school, and a public office have been studied, developed, and practically used.

A type used most frequently among electronic display devices is a liquid crystal type, and is already in practical use for many purposes such as a digital signage. The liquid crystal type generally includes a cell structure in which a liquid crystal material having an intermediate characteristic of crystal and liquid is injected between two substrates such as glasses that are mounted in parallel to each other.

A liquid crystal material has a bar-shaped long molecular structure, and has a characteristic that molecules are arranged in the same direction. Therefore, when a potential difference or the like is applied across two substrates constituting a cell by use of this characteristic, arrangement of molecules can be controlled. It is possible to turn on and off light penetrating the cell by variously changing the arrangement of molecules, and a display element can be provided by use of this characteristic.

A liquid crystal panel using the liquid crystal type is widely used as a display device since the panel has a relatively simple structure and only requires a simple control method of merely controlling a potential difference between two electrodes for the operation. Liquid crystal panels are practically used from a small one such as a mobile device to a large one used in a digital signage or the like. Regarding the purposes, a liquid crystal panel is practically used in a wide range from display of a general television image to display in an electronic device or the like such as a personal computer, and even for a special purpose such as a medical care.

Moreover, a display device using an organic electroluminescence (EL) type that pursues more thinness and fineness has been recently developed, and is almost in practical use. An organic EL type has a structure in which an organic material that emits light when applying an electric field thereto is placed between two electrodes. The types generally used are a single-layer organic EL type in which an organic material includes only one material, and a function-separated laminated organic EL type including a plurality of layers associated with functions such as charge injection, charge transfer, and light emission. The organic EL type is thinner and lighter in the entire panel than liquid crystal, and thus expected to be a next-generation display type. In addition, while the liquid crystal type requires auxiliary light such as backlight, the organic EL type is self-luminous and therefore considered to be capable of finer display.

Furthermore, there is also developed a display device using an electronic paper type and the like that pursue lower power consumption during operation, and a memory property capable of continuous display even when no electric power is supplied. A well-known electronic paper type is a microcapsule type. The microcapsule type has a cell structure in which pigment particles that are different in color and are each positively or negatively charged are enclosed in one small ball-shaped microcapsule, and ink containing this microcapsule is injected between two electrodes. The microcapsule type is a type that performs display by applying voltage across two electrodes, controlling a potential difference between the electrodes, and thus allowing a pigment inside a capsule to move. By applying voltage only when displaying information, this type can keep displaying the displayed information without even applying voltage afterwards. Thereby, it is possible to keep power consumption lower compared to liquid crystal display and organic EL display.

### CITATION LIST

### Patent Literature

[PTL 1] Japanese Laid-open Patent Publication No. 2015-4920

[PTL 2] Japanese Laid-open Patent Publication No. 2013-117599

### SUMMARY OF THE INVENTION

### Technical Problem

On the other hand, it is important that information can be provided at normal times from a viewpoint of use in a poster, a bulletin board, and the like in a public facility or the like, but there are also many demands for conveying other information in emergencies. In this respect, there is a demand for introducing an electronic display device.

When an electronic display device is considered in light of conveyance of information in emergencies, the liquid crystal type and the organic EL type need electric power to perform display, and do not exert any function when electric power is cut off. Among electronic paper types, a general electrophoretic type (e-ink or the like) can keep displaying information, and in this respect, the electronic paper type is considered fit for the purpose. However, there is a problem that display cannot be changed after electric power is cut off, and therefore, a matter wanted to be conveyed is not displayed after all.

PTL 1 discloses a multifunctional signboard device. This multifunctional signboard device includes a visual display layer 1 for performing display as an advertisement, a signboard, a guide display, a sign, or the like at ordinary times on a front surface, a surface light source on a back surface, and a visual display layer 2 for indicating an evacuation route or the like between the visual display layer 1 and the surface light source at a time of disaster. At a time of disaster, the visual display layer 2 is caused to emit light and perform display by a control through a wireless control means. Although display is performed by use of the surface light source and the visual display layer 2 at a time of disaster, electric power is needed and any function is not at all exerted when electric power is cut off.

Moreover, in an emergency when an electronic display device itself is deformed or partly damaged, a liquid crystal type using a glass substrate for the device itself becomes unable to convey information even when electric power is supplied. When the device is deformed or partly damaged, it can also be considered that the device itself becomes inoperable due to leakage of constituent contents or a short circuit between electrodes used in a display panel.

PTL 2 discloses a thickness-reduced electrochromic display device including a thin film battery element. The thin film battery element includes a collector, a first battery electrode layer connected to the collector, and a second battery electrode layer stacked on the first battery electrode layer via a solid electrolyte, and one of two electrochromic layers is connected to a front surface opposite to a back surface of the collector. Display is changed by pushing a switch and thus applying voltage of the thin film battery element across the two electrochromic layers or causing a short circuit therebetween.

However, this PTL 2 does not indicate any case in an emergency when an electrochromic display element is deformed or partly damaged.

In view of the foregoing, an object of the present invention is to provide an electronic display device capable of displaying specifically even when power source supply is interrupted or the device is deformed or the like.

### Solution to Problem

The present invention provides an electronic display device including: an electrochromic element including first and second transparent electrodes, first and second electrochromic thin films which are formed on the first and second transparent electrodes and at least one of which has optical transparency when being charged, and an electrolyte filled between the first and second electrochromic thin films; and

an electrode short-circuit mechanism which causes a short circuit between the first and second transparent electrodes by an external disturbance, thereby emitting a charge and generating a color.

Furthermore, the present invention provides a drive method for an electronic display device, the drive method including: supplying a charge to first and second transparent electrodes of an electrochromic element and thereby causing at least one of first and second electrochromic thin films to be optically transparent, the electrochromic element including the first and second transparent electrodes, the electrochromic thin films formed on the first and second transparent electrodes, and an electrolyte filled between the first and second electrochromic thin films; stopping supply of the charge and maintaining the optical transparency; and emitting the charge by a short circuit between the first and second transparent electrodes during an external disturbance, and thereby generating a color by the electrochromic thin films and displaying information.

### Advantageous Effects of the Invention

It is possible to provide an electronic display device capable of displaying even when power source supply is interrupted or the device is deformed or the like, by use of an electronic display device using an electrochromic element according to the present invention.

### BRIEF DESCRIPTION OF THE DRAWINGS

FIG. 1 is a sectional view illustrating a structure of an electrochromic element used in an example embodiment of the present invention.

FIG. 2 illustrates an example in which an electronic display device according to the example embodiment of the present invention is used as an emergency information display device provided on a bulletin board or the like. (a) illustrates that the electronic display device is a normal floor display board. Information about an evacuation route for an emergency exit or the like is displayed in an emergency, as illustrated in FIG. 2(b). Information about an evacuation route or the like is displayed over the floor display board in an emergency, as illustrated in FIG. 2(b).

FIG. 3 is a diagram illustrating that information about an evacuation route or the like is automatically displayed when the electronic display device according to the example embodiment of the present invention is partly damaged or bent.

FIG. 4 is a diagram illustrating a vibration switch used in an example of the present invention.

FIG. 5 is a diagram illustrating a short-circuit switch used in an example of the present invention.

FIG. 6 is a diagram illustrating a short-circuit switch used in an example of the present invention.

### DESCRIPTION OF THE EMBODIMENTS

As a result of intensive study to solve the previously described problem, the present inventor has discovered that it is effective to use a detachable charge supply device, and an electrode short-circuit mechanism capable of causing a short circuit between electrodes in emergencies or the like. The present inventor has created the present invention after discovering that the charge supply device and the electrode short-circuit mechanism make it possible to obtain an electronic display device capable of displaying even when power source supply is interrupted or the entire device is deformed or the like.

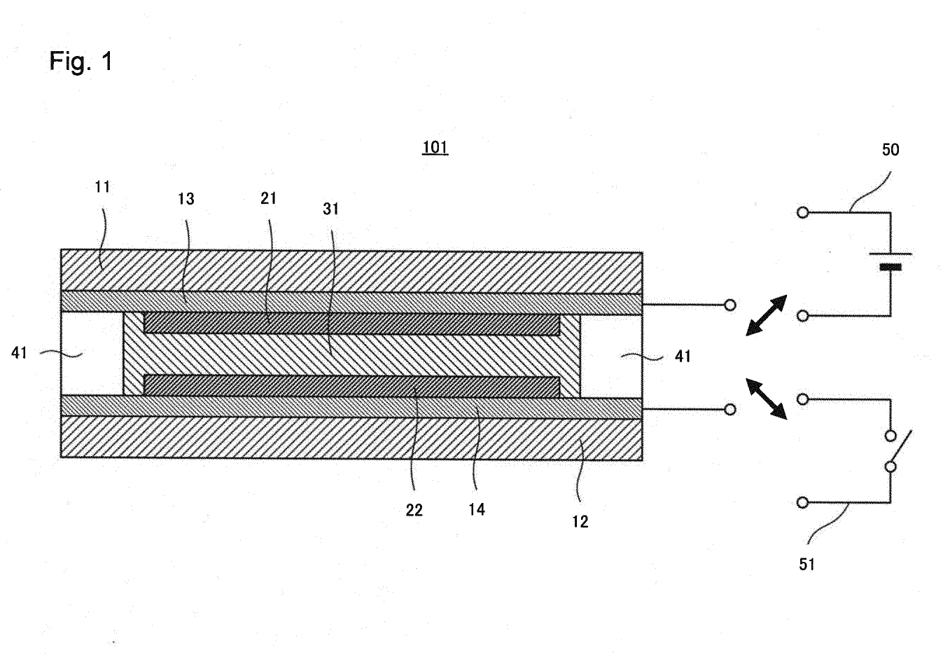

A structure of an electrochromic element 101 used in an example embodiment of the present invention is illustrated in FIG. 1. The electrochromic element forms electrochromic materials 21 and 22 having two kinds of oxidation-reduction states in each of two opposed electrodes 13 and 14 provided on substrates 11 and 12. Further, the electrochromic element has a cell structure filled with an electrolyte 31 capable of conducting a charge or an ion in a space between the two opposed electrochromic materials 21 and 22, and cell periphery is closely sealed with a sealing material 41. A shape of the electrodes 13 and 14 is a shape of information wanted to be displayed, such as a character, a figure, or a picture.

The electrochromic material formed on the electrode can change color according to a charge amount (oxidation state↔reduction state) therein, and display information. In this electrochromic element, when one of the electrochromic materials formed on the two electrodes is brought into an oxidation state, the other material is brought into a reduction state, whereas when one is brought into a reduction state, the other is brought into an oxidation state. Thus, the electrochromic element can display information by controlling the oxidation/reduction state of the two electrochromic materials. Further, structurally speaking, the electrochromic element controls two oxidation/reduction materials by two electrodes and takes advantage of charge transfer of an internal electrolyte. In this respect, the electrochromic element is a kind of battery, and can be also said to be an element that changes display by changing color in two states including a charge state and a discharge state.

When this element is normally operated, the two opposed electrodes 13 and 14 are kept out of contact with each other. When in contact, the electrodes are in a short-circuit state, and therefore cannot cause a color change.

In regard to operation, display is changed by applying a voltage to each electrode and switching between a charge state and a discharge state, and whether to generate a color during charging or discharging is determined by a combination of the electrochromic materials, whereby operation can be controlled.

By selecting a material that generates a color during discharging and normally putting in a charge state, no information is displayed during normal indication. In emergencies or the like, a short circuit is caused between the electrodes intentionally or when device deformation or the like occurs, by use of the electrode short-circuit mechanism used in the electronic display device according to the present invention. Thereby, it is possible to display information when an electrode short circuit occurs.

A more detailed description is given below.

An inorganic material such as glass or silicon, and plastic such as acrylic resin, polyester resin, or polycarbonate resin can be used as a material of the two substrates 11 and 12 constituting the electrochromic element. A material of substrates 11 and 12 is not specifically limited as long as the material can hold the electrodes and the electrochromic materials formed thereon. Note that when the structure of the electrochromic display element can be sufficiently supported by a component other than the substrate such as an electrode material, the electrode material or the like also serves as a substrate, and it is therefore possible to use no additional substrate.

In regard to properties required for a substrate, a particularly high heat resistance property and chemical resistance property are not necessary unless the substrate is not deteriorated or eroded by heat applied when manufacturing a cell, an internally formed electrolyte, or the like. However, in consideration for using in the display element, it is preferable to use a substrate having high optical transparency (transparency). In particular, a substrate on a side that is assumed to be seen by a person is preferably transparent. The same material or different materials may be used for two substrates, and for example, it is possible to form two substrates of glass and silicon, or form two substrates of a transparent polyester film and a colored polyimide film. In this case, precise information can be conveyed when a side arranged with the transparent substrate is a front side of the display device (a direction in which a person sees).

Materials that can be used as the electrodes 13 and 14, respectively, include an organic material such as conductive polymer, in addition to metals and alloys such as an indium tin oxide (ITO) alloy, a tin oxide (NESA), gold, silver, platinum, copper, indium, aluminum, magnesium, a magnesium-indium alloy, a magnesium-aluminum alloy, an aluminum-lithium alloy, an aluminum-scandium-lithium alloy, and a magnesium-silver alloy. As properties required for the electrodes 13 and 14, a particularly high heat resistance property and chemical resistance property are not necessary, but in consideration for using in the display element as in the case of the substrate, it is preferable to use a substrate having high optical transparency (transparency). In particular, for an electrode on a side formed on a substrate on a side seen by a person, a transparent and conductive material of oxide such as ITO is preferable to a metal material such as gold. Note that even the semitransparent electrodes 13 and 14 can be used when their optical transparency is enough to confirm information during a short circuit, and fall within a transparent electrode according to the present invention.

As a method for producing the electrodes 13 and 14, a normal electrode formation process such as a vacuum deposition method, a sputtering method, an etching method, and lift-off can be used, and there is no specific limitation. Further, when an organic material such as conductive polymer, a dispersion liquid containing silver paste and metal particles, or a metal organic compound is used as an electrode, it is possible to use a solution process such as a spin coat method, a dipping method, a dispenser method, or an ink jet method, and there is no specific limitation in this case as well. Moreover, when the electrodes 13 and 14 are processed by patterning, it is possible to use a general photolithographic etching method, a patterning method using a shadow mask, or the like. When formed from the solution process, the electrodes 13 and 14 can be directly drawn by the dispenser method or the ink jet method.

A chemical material that changes light absorption by transferring charges is used as a material for the electrochromic materials 21 and 22. Such a material includes an inorganic material such as tungsten oxide, an inorganic pigment such as Prussian blue and its analogues, and an organic pigment such as viologen. Such a material has its substance oxidized or reduced by transfer of charges, varies in absorption wavelength in its state, and therefore causes a color change due to transfer of charges. Note that as far as only one of the electrochromic materials 21 and 22 is concerned, it is possible to use a material that does not change color even when transfer of charges (oxidation or reduction) occurs, or a material that is transparent in both states. In general, such a material is often stable in an oxidation state or a reduction state, and it is preferable for the electrochromic element to use a combination of two materials which are a material stable in an oxidation state and a material stable in a reduction state.

As a material for the electrolyte 31, a material capable of conducting a charge or an ion in a state of solution, gel, solid, or the like can be used. In general, it is possible to use any electrolyte solution as long as including a substance that is ionized into ions or the like in a solvent, and a solution, and there is no specific limitation. When used as a solution without any change, an electrolyte solution is often used in a gel state because of concern for liquid leakage from a cell and the like. In the case of an electrochromic element, some substances change color by transfer of a particular ion such as a potassium ion, for example, in which case an electrolyte such as potassium trifluoromethanesulfonimide may be used.

As a material for the sealing material 41, a general silicone-based or resin-based adhesive agent can be used. Although no specific performance is required for a heat resistance property and hardness of an adhesive agent, it is advantageous to select a material that is not eroded by an electrolyte particularly when the electrolyte 31 is liquid.

While a general power source device can be used as a charge supply device 50 for use in the present example embodiment, the electrochromic element according to the present example embodiment is preferably operated by a direct-current power supply. Therefore, it is advantageous to use a direct-current power source device including a primary battery such as a dry battery and a secondary battery such as a lithium-ion battery, an AC-DC conversion power source device equipped with a rectification circuit, or the like. The charge supply device 50 is not specifically limited in size, shape, and the like as long as the charge supply device 50 can supply a sufficient charge amount that can operate the electrochromic element. The charge supply device 50 is separated from the electrodes 13 and 14 after operating the electrochromic element and causing the electrochromic element to generate a color, and an electrode short-circuit mechanism 51 is connected to the electrodes 13 and 14 instead.

The electrode short-circuit mechanism 51 used in the present example embodiment is not limited in shape and type as long as the electrode short-circuit mechanism 51 has a function that can automatically or manually cause a short circuit between electrodes when needed due to occurrence of an external disturbance. Further, whether provided outside or inside of an electrochromic cell, the electrode short-circuit mechanism 51 can be used in either case as long as the electrode short-circuit mechanism 51 has a function that can cause a short circuit between electrodes.

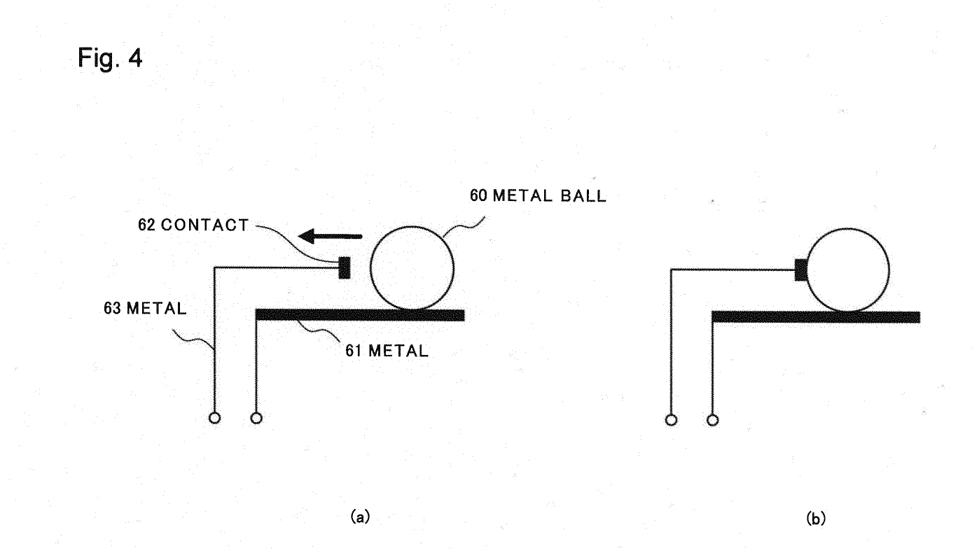

Moreover, an external disturbance referred to herein indicates a disaster such as an earthquake, a fire, water damage, a strong wind, a typhoon, and an accident, and pressing by a person with a finger or the like. The electrode short-circuit mechanism is activated on the occurrence of an external disturbance, and can cause a short circuit between electrodes of an electrochromic cell. When great vibration different from that in peacetime is generated by an earthquake, a strong wind, a typhoon, an accident, or the like, it is possible to use a vibration switch or a tilt switch (an example is illustrated in FIG. 4) capable of sensing vibration or quake and then causing a short circuit. For example, a tilt switch manufactured by Akizuki Denshi Tsusho contains a spherical ball therein, and can cause a short circuit between electrodes by movement of this ball.

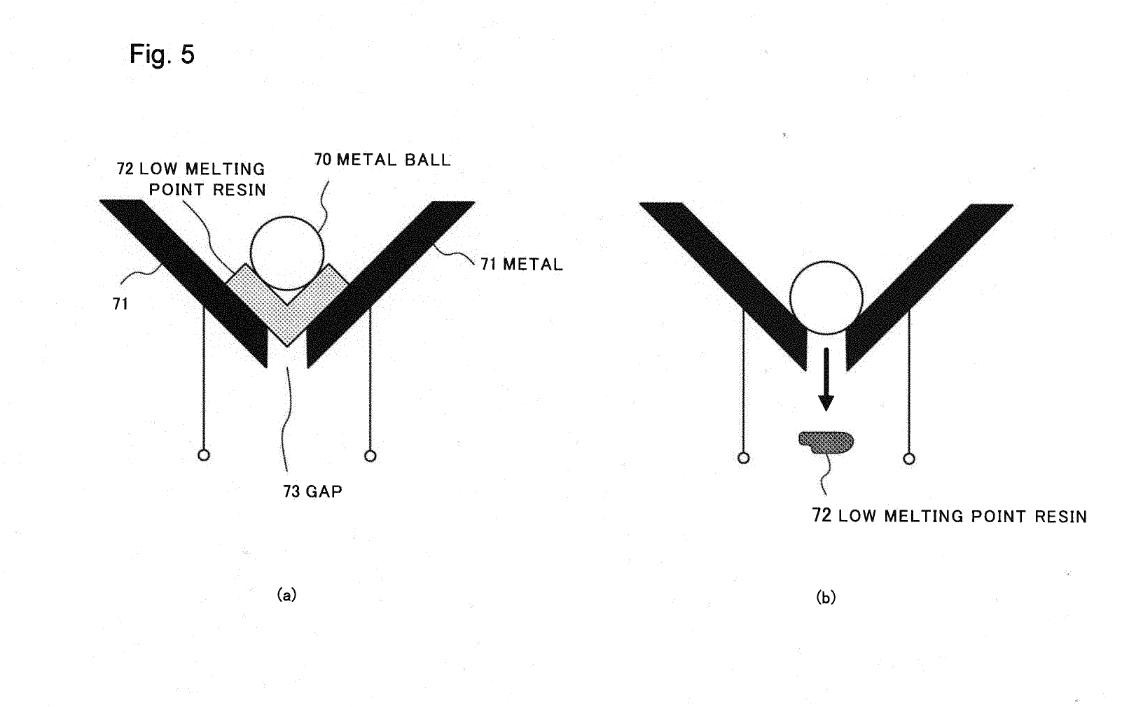

In the case of a fire or the like in which generation of heat is assumed, it is advantageous to put, between two electrodes of the electrochromic element, resin or a paste thin film that melts at a temperature equal to or more than normal temperature (operating temperature), for example, at 80° C. or more. Consequently, it is possible to provide a mechanism in which the two electrodes are electrically insulated from each other at normal times, and the resin between the electrodes melts and a short circuit is caused between electrodes at the time of heating (an example is illustrated in FIG. 5). Herein, as resin or a paste thin film that melts at 80° C. or more, it is possible to use a plastic material such as polyvinylchloride (a melting point of 85° C. or more) or acrylic resin (a melting point of 90° C. or more), a paraffin compound having a carbon number of 40 or more (a melting point of tetracontane having a carbon number of 40 is 80 to 85° C.), wax such as montan wax (a melting point of 82° C.) and carnauba wax (a melting point of 82.5° C.), or wax such as Licowax LP (a melting point of 82° C. or more) and microcrystalline wax W445 (a melting point of 83.9° C. or more).

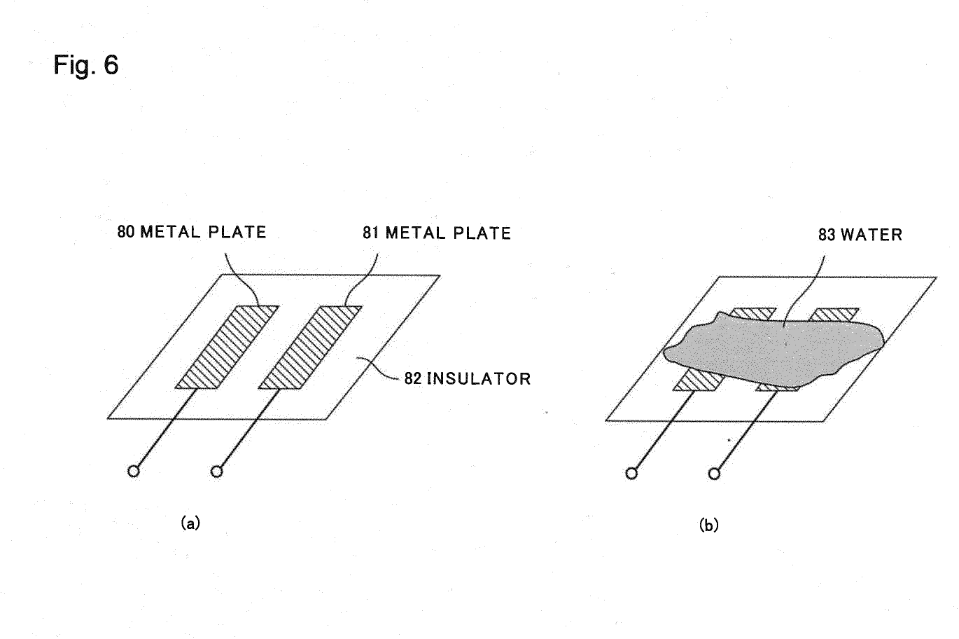

Furthermore, in the case where occurrence of flooding or the like is assumed due to water damage, a pair of electrodes are arranged at regular intervals so that a current flows between the electrodes and a short circuit state can be created when the electrodes are soaked in water (an example is illustrated in FIG. 6). In addition, this electrode short-circuit mechanism can be provided not only outside the electrochromic cell as described above, but also inside the electrochromic cell. Moreover, a short circuit state may be created by causing a short circuit between the electrodes constituting the electrochromic cell directly with external stress from a finger or the like. Alternatively, when the cell itself is bent or deformed, the short circuit state may be created by causing a short circuit between the electrodes themselves in a bent part or a deformed part.

While components of the electrochromic element according to the present example embodiment have been described above, the electrochromic element is not limited to the materials, devices, and mechanisms described above by way of example as long as a material, a device, and a mechanism fulfills a condition formed by each item.

### Example 1

A film was formed with an ITO electrode of approximately 10 μm on a polyethylene terephthalate (PET) film having a thickness of 100 μm by a sputtering method to produce a transparent substrate equipped with a transparent electrode and to produce two substrates of 5 cm square. As an electrochromic material, a film was formed on one substrate by a spin coat method with the use of ink in which a Prussian blue (PB) pigment was dispersed into water. Further, a film was formed on the other substrate by the spin coat method with the use of ink in which Ni-Prussian blue analogues (Ni-PBA) were dispersed into water. Thereby, the substrates equipped with the electrochromic materials were produced for one each. The substrate coated with PB was coated with thermosetting epoxy resin by use of a dispenser device, and the inside was filled with a propylene carbonate solution. Specifically, the substrate of 5 cm×5 cm was coated with epoxy resin having a width of 100 μm in the shape of a 3 cm sized quadrate frame which was heaped up to form a sealing material. The inside surrounded by this sealing material was filled with a propylene carbonate solution which was an electrolyte. The substrate coated with Ni-PBA was attached from the above in such a way that electrodes faced each other and an epoxy-based adhesive agent was cured by adding heat to produce an electrochromic element 101. The electrodes are shaped into a character, a figure, and the like as wanted to be displayed.

A potential of −1.5V was applied to the produced element 101 on the PB electrode side, and a potential of 0V was applied on the Ni-PBA electrode side (a potential difference of 1.5V). Accordingly, the PB pigment of the element 101 changed from blue to a colorless state.

In the electrochromic element based on the present example embodiment, a color change can be made by a voltage of approximately 1.5V as shown in Example 1. As compared with a voltage of several ten volts required by the microcapsule type electronic paper medium described in Background Art, reduction in power consumption can be achieved.

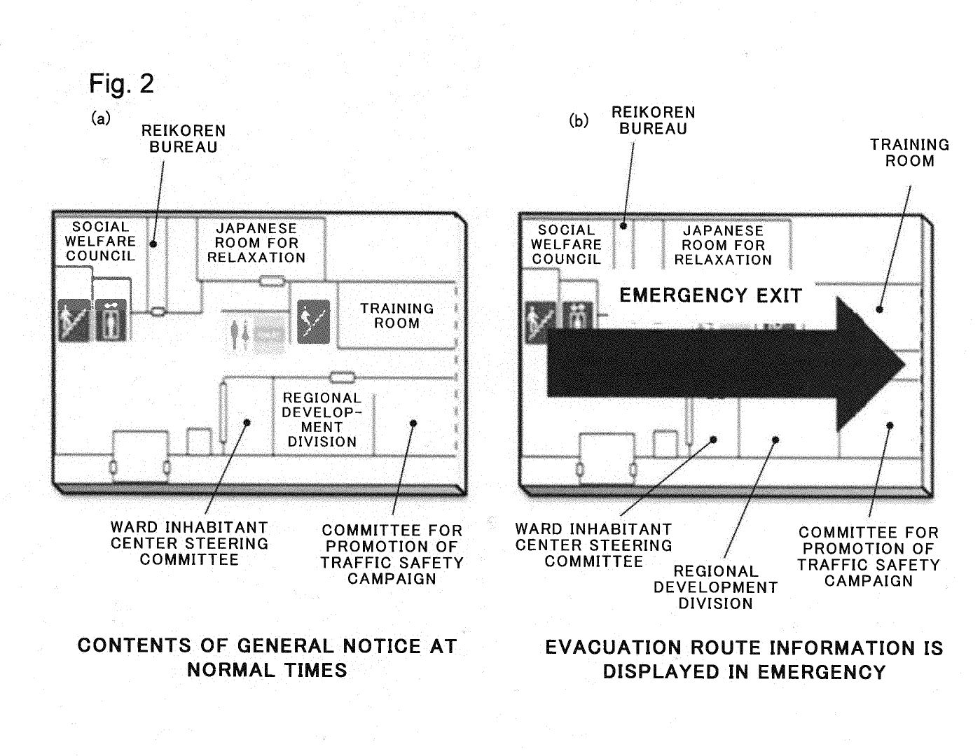

Furthermore, in the electrochromic element based on the present example embodiment, it is possible to produce a light transmissive display element by selecting transparent substrate and electrode materials and selecting, as an electrochromic material, a material that becomes transparent in either one of the oxidation and reduction reactions. As a result, it is possible to produce a display device in which other information is indicated on a lower part of the element as in FIG. 2. FIG. 2 illustrates an example in which the electronic display device is used as an emergency information display device provided on a bulletin board or the like. FIG. 2(a) illustrates a general floor display board in a building at normal times. In an emergency, information about an evacuation route or the like is displayed over the floor display board as illustrated in FIG. 2(b). Herein, colored characters “emergency exit” and arrow of the route are displayed.

### Example 2

The electrochromic element 101 produced in Example 1 was attached onto a printed poster, and with the electrochromic element 101 being attached to the poster, a potential of −1.5V was applied on the PB electrode side, and a potential of 0V was applied on the Ni-PBA electrode side (a potential difference of 1.5V), by use of the charge supply device 50. Accordingly, the electrochromic element 101 became almost transparent, and the information on the poster in the lower part could be read without trouble. In this state, when the voltages applied to the two electrodes were eliminated, the element 101 remained transparent, and the information on the poster in the lower part could be read even three days later.

A short circuit was caused between these electrodes by use of the electrode short-circuit mechanism 51 (a simple manual switch in the case of the present example embodiment), and a discharge state was formed by eliminating a charge held between elements. Consequently, PB of the element 101 generated blue color, and new information was able to be displayed. Even when a short circuit state between the two electrodes was eliminated in this state, the generation of blue color continued, and the information were able to be kept displayed.

Information with completely different characteristics can be transmitted in one medium by use of the electrochromic element based on the present example embodiment. In particular, the element becomes almost transparent, which permits normal information to be transmitted at normal times without making aware of electrochromically displayed information. Further, in an emergency, an evacuation route or evacuation information, for example, can be displayed over general information and can be kept displayed only for a required amount of time.

When an electrochromic display element is operated, it is preferable to cause no electrical short circuit between two electrodes, as has previously been described. When a short circuit is caused, oxidation and reduction reactions of the electrochromic material do not progress, and the element cannot be brought into a charge state, so that no change of display occurs. In order to prevent such a short circuit, in general, an electrolyte often has microparticles or the like mixed therein, and is used as a spacer. In general, silica particles are often used as microparticles to be mixed in. Polymer microparticles such as acrylic resin or the like can be used as long as it cannot be dissolved in the electrolyte.

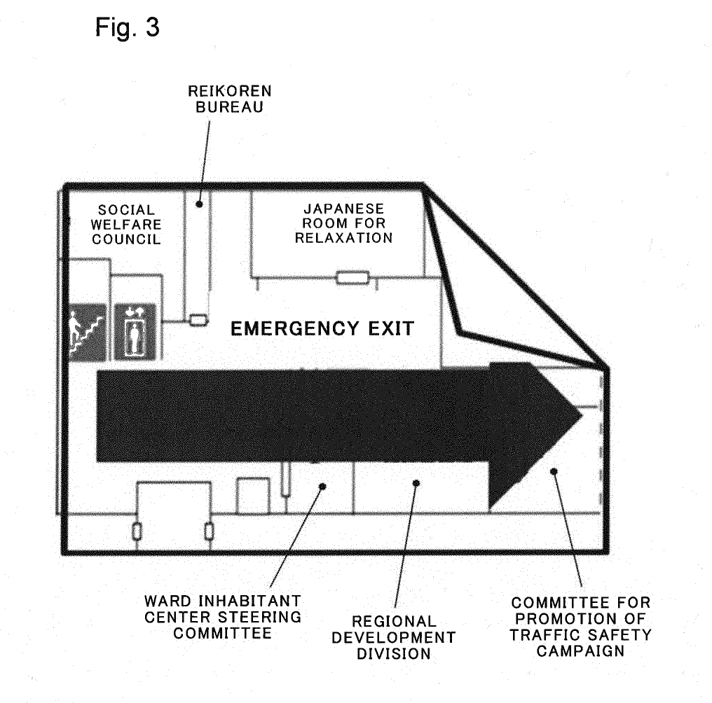

Herein, a film substrate that is not damaged even when bent is used as a substrate, and an electrochromic element that generates a color during a discharge state is used. Consequently, when the entire display medium is damaged, deformed, or the like, the electrochromic element formed by the film is not damaged in its entirety, but contact between some electrodes occurs, as illustrated in FIG. 3. This contact operates as the electrode short-circuit mechanism 51, and charge in the element is discharged, so that information can be switched and displayed. FIG. 3 illustrates that information about an evacuation route or the like is automatically displayed when the electronic display device according to the present example embodiment is partly damaged or bent.

The general display element described as a background art requires some electric power when rewriting information. However, in the case of the electrochromic element according to the present example embodiment, information is automatically rewritten with no supply of electric power, by charge transfer in the element itself held in a charge state at normal times.

### Example 3

In the poster to which the electrochromic element produced in Example 2 was attached, the electrochromic element was brought into a transparent state by applying a potential of −1.5V on the PB electrode side and a potential of 0V on the Ni-PBA electrode side (a potential difference of 1.5V). Thereafter, the voltage supply to the electrodes was stopped, and a part of the poster was bent with wiring and the like removed. Consequently, contact between electrodes in the bent part occurred, and information similar to that in an electrically short-circuited state were able to be displayed.

When information cannot be automatically displayed due to damage or the like to this poster, information can be artificially displayed. As has been described in Example 2, microparticles to be a spacer are often mixed into an electrolyte in order to prevent a short circuit between electrodes in the case of an electrochromic element. In the present example, no microparticles are mixed in. In other words, a short circuit state is formed by contact between electrodes even when pressure is applied to any area with a finger or the like, and information can be displayed in any manner. In this case as well, no electric power is needed to display information, and necessary information can be provided even in an emergency in which power source supply is interrupted. Pressing with a finger also falls within an external disturbance.

### Example 4

In the poster to which the electrochromic element produced in Example 2 was attached, the electrochromic element was brought into a transparent state by applying a potential of −1.5V on the PB electrode side and a potential of 0V on the Ni-PBA electrode side (a potential difference of 1.5 V) with the use of the charge supply device 50. Thereafter, the charge supply device 50 was detached, and the voltage supply to the electrodes was thus stopped. In this state, a part of the poster was pressed with a finger, electrodes were thus brought into contact with each other to operate as the electrode short-circuit mechanism 51, and information was able to be switched and displayed. In the present example, a short circuit state during normal use is prevented by putting a spacer in the electrolyte of the entire poster, but a part having no spacer (or a small amount of spacer) therein is provided. When this part is pressed with a finger or the like, a short circuit state can be created. It is advantageous to provide a plurality of parts having no spacer or a small amount of spacer mixed therein on a poster, or provide such a part in a place easy for a person to touch with a hand, in such a way as to enable display with high probability even in an emergency.

### Example 5

In the present example, a tilt switch having a structure as illustrated in FIG. 4 is used as the electrode short-circuit mechanism 51. Other than this, a configuration and an operation method are similar to those in Examples 3 and 4, and are therefore omitted herein. The tilt switch used as the electrode short-circuit mechanism 51 in the present example is described. The present tilt switch has a structure as illustrated in FIG. 4(a). A metal ball 60 is put on a metal 61, and can roll on the metal 61. A metal 63 is provided parallel to the metal 61, and its front edge is a contact 62. The contact 62 and the contact 61 are connected to the electrode 13 and the electrode 14 of the electrochromic element, respectively.

At ordinary times, this tilt switch is horizontally mounted, and the metal ball 60 is present at a position on the contact 61 and out of contact with the contact 62. Then, the metal ball 60 rolls by applying vibration or impact to the tilt switch due to an external disturbance such as an earthquake or an accident, and when the metal ball 60 comes in contact with the contact 62, a short circuit is caused between terminals. As a result, a short circuit was caused between the electrodes 13 and 14 to which the electrode short-circuit mechanism 51 was connected, and information was able to be switched and displayed.

Note that in the present example, the tilt switch has been described as a one-dimensional switch in which the contact is mounted only in one direction. However, the contact may be mounted not only in one direction but also in a plurality of directions, and the present invention is not limited to the structure in the present example as long as a function that causes a short circuit between contacts by vibration, impact, or the like is provided.

### Example 6

In the present example, a heat-melting short-circuit mechanism having a structure as illustrated in FIG. 5 and having a function for causing a short circuit between terminals by overheating is used as the electrode short-circuit mechanism 51. Other than this, a configuration and an operation method are similar to those in Examples 3 and 4, and are therefore omitted herein. The heat-melting short-circuit mechanism used as the electrode short-circuit mechanism 51 in the present example is described.

The present heat-melting short-circuit mechanism has a structure as illustrated in FIG. 5(a). In other words, two metals 71, 71 are arranged in such a way that their front edges face each other across a gap 73. A low melting point resin 72 including Licowax LP is mounted on the metals 71 across the gap 73. A metal ball 70 is put on the low melting point resin 72. The two metals 71, 71 are connected to the electrode 13 and the electrode 14 of the electrochromic element, respectively.

The low melting point resin 72 only has to be a material having a low melting point and showing insulating properties (high resistance) at normal temperature. At ordinary times, the metal ball 70 is mounted on the low melting point resin 72 which is an insulator. Thus, a state between terminals is open, and there is no electrical short circuit. However, when heat different from normal heat is applied and the present heat-melting short-circuit mechanism is heated due to an external disturbance such as a fire, a breakdown, or abnormal heating, the low melting point resin 72 melts and runs down from the gap 73, and the metal ball 70 falls down, leading to a short circuit between terminals, as illustrated in FIG. 5(b). As a result, a short circuit was caused between the electrodes 13 and 14 to which the electrode short-circuit mechanism 51 was connected, and it was possible to switch to a display for an emergency.

Note that the present heat-melting short-circuit mechanism only illustrates an example in which a short circuit is caused between terminals by heat, and the present invention is not limited to this form as long as a function for causing a short circuit between terminals by heat is provided. For example, a mechanism in which a low melting point metal melts down by heat and a short circuit is thus caused between terminals may be used, or a mechanism that changes electrical resistance by heat may be used.

### Example 7

In the present example, used as the electrode short-circuit mechanism 51 is a water leakage detection short-circuit mechanism that is formed by a structure as illustrated in FIG. 5 and that has a function for causing a short circuit between terminals by an electrically conductive liquid such as water. Other than this, a configuration and an operation method are similar to those in Examples 3 and 4, and are therefore omitted herein. The water leakage detection short-circuit mechanism used as the electrode short-circuit mechanism 51 in the present example is described.

The present water leakage detection short-circuit mechanism has a configuration as illustrated in FIG. 6(a), and a metal plate 80 and a metal plate 81 are mounted on an insulator 82 at a predetermined interval. At ordinary times, no short circuit is caused between terminals because the metal plates 80 and 81 are arranged at a predetermined interval in a form of the insulator. However, when the present water leakage detection short-circuit mechanism is subjected to a water 83 due to an external disturbance such as water damage, an accident, or a heavy rain, a short circuit is caused between the metal plates 80 and 81 by water, and a short circuit is thus caused between terminals, as illustrated in FIG. 6(b). As a result, a short circuit was caused between the electrodes 13 and 14 to which the electrode short-circuit mechanism 51 was connected, and information were able to be switched and displayed.

Note that the present water leakage detection short-circuit mechanism only illustrates an example in which a short circuit is caused between terminals by water. The water leakage detection short-circuit mechanism is not limited to this form as long as a function for causing a short circuit between terminals by water is provided, and further, an electrically conductive liquid other than water may be used. When a low melting point metal is disposed in an upper part of the present water leakage detection short-circuit mechanism, and is structured to run down on the metal plates 80 and 81 when melted by heat, it is possible to be used as the electrode short-circuit mechanism 51 that switches a display of the electrochromic element in the event of a fire or the like.

While the examples of the electrode short-circuit mechanism have been described above, the electrode short-circuit mechanism is not limited to the methods described in the present examples as long as there is provided a function for causing a short circuit between terminals due to an external disturbance resulting from a disaster such as an earthquake, a fire, water damage, a strong wind, a typhoon, or an accident, or pressing by a person. Moreover, it goes without saying that instead of a single electrode short-circuit mechanism described in the invention of the present application, it is possible to employ a plurality of electrode short-circuit mechanisms that are combined and simultaneously operate for a plurality of external disturbances.

Furthermore, although the electrochromic element 101 according to the present invention attached to a poster has been shown in the examples described above, various other applications are conceivable. By way of an example, it is possible to conceive an application in which the electrochromic element 101 is attached to a wall, a pillar, a door, a desk, a copy machine, a cabinet, or the like, and is normally transparent and inconspicuous, but an evacuation direction appears once a short circuit is caused in a power supply. This electrochromic element 101 is advantageously attached to a place where a person easily gets lost during evacuation.

The example embodiment described above can be partly or entirely described as in Supplementary notes below, but is not limited to the followings.

### Supplementary Note 1

An electronic display device including:

an electrochromic element including first and second transparent electrodes, first and second electrochromic thin films which are formed on the first and second transparent electrodes and at least one of which is charged and thus has optical transparency, and an electrolyte filled between the first and second electrochromic thin films; and

an electrode short-circuit mechanism which causes a short circuit between the first and second transparent electrodes by an external disturbance, thereby emitting a charge and generating a color.

### Supplementary Note 2

The electronic display device according to Supplementary note 1, wherein the charging is conducted by a charge supply device which supplies a charge to the first and second transparent electrodes and which is attachable to and detachable from the electronic display device.

### Supplementary Note 3

The electronic display device according to Supplementary note 1 or 2, wherein one of the first and second electrochromic thin films contains a Prussian blue pigment as a main material, and the other contains Prussian blue analogues as a main material.

### Supplementary Note 4

The electronic display device according to any one of Supplementary notes 1 to 3, wherein an electrolyte contains potassium trifluoromethanesulfonimide.

### Supplementary Note 5

The electronic display device according to any one of Supplementary notes 1 to 4, wherein the external disturbance is a disaster.

### Supplementary Note 6

The electronic display device according to any one of Supplementary notes 1 to 5, wherein the external disturbance is a disaster such as an earthquake, a fire, water damage, a strong wind, a typhoon, or an accident, or pressing with a finger.

### Supplementary Note 7

The electronic display device according to any one of Supplementary notes 1 to 5, wherein the electrode short-circuit mechanism is a tilt switch.

### Supplementary Note 8

The electronic display device according to Supplementary note 7, wherein the tilt switch includes a contact and a metal ball, and a short circuit is caused between the contact and the metal ball by vibration.

### Supplementary Note 9

The electronic display device according to any one of Supplementary notes 1 to 7, wherein the electrode short-circuit mechanism is a short-circuit switch.

### Supplementary Note 10

The electronic display device according to Supplementary note 9, wherein the short-circuit switch is a heat-melting short-circuit mechanism.

### Supplementary Note 11

The electronic display device according to Supplementary note 10, wherein the heat-melting short-circuit mechanism includes two metals facing each other across a gap, a low melting point resin mounted across the gap, and a metal ball mounted on the low melting point resin, and when heated, the low melting point resin melts to allow the metal ball to fall down, thereby causing a short circuit between the two metals.

### Supplementary Note 12

The electronic display device according to any one of Supplementary notes 1 to 6, wherein the electrode short-circuit mechanism forms a place where the first and second transparent electrodes easily come in contact with each other.

### Supplementary Note 13

The electronic display device according to Supplementary note 12, wherein the place where the first and second transparent electrodes easily come in contact with each other is a place where microparticles to be a spacer mixed into the electrolyte are not mixed or are mixed in small amounts.

### Supplementary Note 14

A drive method for an electronic display device, including: supplying a charge to first and second transparent electrodes of an electrochromic element to make at least one of first and second electrochromic thin films to be optically transparent, the electrochromic element including the first and second transparent electrodes, the electrochromic thin films formed on the first and second transparent electrodes, and an electrolyte filled between the first and second electrochromic thin films;

stopping supply of the charge to maintain the optical transparency; and

emitting the charge by a short circuit between the first and second transparent electrodes caused during an external disturbance, whereby the electrochromic thin films generate a color and display information.

### Supplementary Note 15

The drive method for the electronic display device according to Supplementary note 14, wherein when the electronic display device is physically damaged or deformed, a short circuit is caused between the first and second transparent electrodes by a contact between the first and second transparent electrodes.

The present invention has been described above with the above example embodiment as an exemplar. However, the present invention is not limited to the example embodiment described above. In other words, various aspects that can be appreciated by those skilled in the art are applicable to the present invention within the scope of the present invention.

This application is based upon and claims the benefit of priority from Japanese patent application No. 2015-181727, filed on Sep. 15, 2015, the disclosure of which is incorporated herein in its entirety by reference.

### REFERENCE SIGNS LIST

11, 12 Substrate
13, 14 Electrode
21, 22 Electrochromic material
31 Electrolyte
50 Charge supply device
51 Electrode short-circuit mechanism
60, 70 Metal ball
61, 71 Metal
62 Contact
72 Low melting point resin
73 Gap
80, 81 Metal plate
82 Insulator
83 Water

What is claimed is:

1. An electronic display device comprising:
an electrochromic element including first and second transparent electrodes, a first electrochromic thin film which are formed on the first transparent electrode, a second electrochromic thin film which are formed on the second transparent electrode and at least one of the first and second electrochromic thin films is charged and thus has optical transparency, and an electrolyte filled between the first and second electrochromic thin films; and
an electrode short-circuit mechanism which causes a short circuit between the first and second transparent electrodes by an external disturbance, thereby emitting a charge and generating a color.

2. The electronic display device according to claim 1, wherein the charging is conducted by a charge supply device which supplies a charge to the first and second transparent electrodes and which is attachable to and detachable from the electronic display device.

3. The electronic display device according to claim 1, wherein one of the first and second electrochromic thin films contains a Prussian blue pigment as a main material, and the other contains Prussian blue analogues as a main material.

4. The electronic display device according to claim 1, wherein an electrolyte contains potassium trifluoromethanesulfonimide.

5. The electronic display device according to claim 1, wherein the external disturbance is a disaster or pressing with a finger.

6. The electronic display device according to claim 1, wherein the electrode short-circuit mechanism is a tilt switch.

7. The electronic display device according to claim 1, wherein the electrode short-circuit mechanism is a short-circuit switch.

8. The electronic display device according to claim 1, wherein the electrode short-circuit mechanism forms a place where the first and second transparent electrodes easily come in contact with each other.

9. A drive method for an electronic display device, the drive method comprising: supplying a charge to first and second transparent electrodes of an electrochromic element and thereby causing at least one of first and second electrochromic thin films to be optically transparent, the electrochromic element including the first and second transparent electrodes, a first electrochromic thin film which are formed on the first transparent electrode, a second electrochromic thin film which are formed on the second transparent electrode and at least one of the first and second electrochromic thin films, and an electrolyte filled between the first and second electrochromic thin films; stopping supply of the charge and maintaining the optical transparency; and emitting the charge by a short circuit between the first and second transparent electrodes during an external disturbance, and thereby generating a color by the electrochromic thin films and displaying information.

10. The drive method for the electronic display device according to claim 9, wherein, when the electronic display device is physically damaged or deformed, a short circuit is caused between the first and second transparent electrodes by a contact between the first and second transparent electrodes.
